(19) United States
(12) Patent Application Publication
(10) Pub. No.: US 2025/0073574 A1
(43) Pub. Date: Mar. 6, 2025

(54) Vehicle Rear Seat Entertainment Integration Module

(71) Applicant: Jet Optoelectronics Co., Ltd., Taipei City (TW)

(72) Inventors: Yu-Feng Chen Lee, Taipei City (TW); Sheng-Yueh Lin, Taipei City (TW)

(21) Appl. No.: 18/794,483

(22) Filed: Aug. 5, 2024

(30) Foreign Application Priority Data
Aug. 31, 2023 (TW) 112133042

(51) Int. Cl. A63F 13/235; G06F 3/02

(52) U.S. Cl. CPC A63F 13/235; G06F 3/02

(57) ABSTRACT

A vehicle rear seat entertainment integration module is provided, the vehicle rear seat entertainment integration module has a display and a multi-functional remote controller, wherein the top of the display has an accommodating space for storing the multi-functional remote controller to solve the problem of losing the multifunctional remote controller due to the lack of storage space. In addition, the multifunctional remote controller may be used as a game handle to enhance the entertainment value of the rear seat of the vehicle.

### CROSS-REFERENCE TO RELATED APPLICATION

This application claims priority from Taiwan Patent Application No. 112133042, filed on Aug. 31, 2023, in the Taiwan Intellectual Property Office, the content of which is hereby incorporated by reference in its entirety for all purposes.

### BACKGROUND OF THE INVENTION

### 1. Field of the Invention

The present disclosure relates to a vehicle rear seat entertainment integration module, particularly to a vehicle rear seat entertainment integration module that may accommodate a multi-functional remote controller for use as a game handle.

### 2. Description of the Related Art

With the advancement of technology and the demand of human beings for audio-visual entertainment, all kinds of display-related audio-visual equipment have been widely used in homes, companies, public places, medium and large-sized vehicles, airplanes, cruise ships, etc. During the commute to work or long-distance travel, to pass a long period of boredom on the transportation system, there already have been entertainment devices to entertain passengers, such as stereos or displays. These devices are provided for passengers to listen to music or watch movies, etc., in order to pass the time when taking the transportation.

However, there is no corresponding space for storing the remote control of displays installed on the rear seats of vehicles in general. A place needs to be found or an extra storage box is required to store the remote control in the vehicle compartment space, leading to the extra storage box taking up in the vehicle compartment space, further creating a poor riding experience for passengers. Remote controls are also likely to be lost and difficult to retrieve.

On the other hand, remote controls in general only include the functions of selecting audio-visual platforms to watch, adjusting volume levels, and pausing the video playback, and do not have the function of serving as an entertainment input device such as a game handle, resulting in reducing the functionality of rear seat entertainment. Furthermore, even though some companies have designed the buttons of the remote control to have the function of a game handle, the design of the buttons still caters to the remote control commonly known in the art, leading to a poor operating experience despite the remote control being able to be used as a game handle.

In summary, a vehicle rear seat entertainment integration module having the function of storing a remote control has to be developed to solve the aforementioned problems.

### SUMMARY OF THE INVENTION

In view of the problems in the prior art mentioned above, the present disclosure aims to provide a vehicle rear seat entertainment integration module with a remote control storing function that may be used as a game handle.

To achieve the purpose, the present disclosure provides a vehicle rear seat entertainment integration module, including a display and a multi-functional remote controller, wherein a top of the display is disposed with an accommodating space for placing the multi-functional remote controller; moreover, a bracket fixing slot is provided at a center of a back of the display, which is combined with the bracket fixing seat at the headrest of the rear seat of the vehicle, so as to make the display fixed on the rear seat of the vehicle.

Preferably, the back of the display is further disposed with a ring-shaped ambient light, which is disposed along an outer side of the bracket fixing slot; the ring-shaped ambient light makes different changes in lighting effects according to usage scenarios of the vehicle rear seat entertainment integration module, so as to enhance the user experience. For example, when music is played, the light may change color or brightness along with the music, or when a game is played, the light may respond to the sound effects with corresponding lighting effects.

Preferably, the accommodating space may be further disposed with any conventional pressing structure to facilitate the removal or fixation of the multi-functional remote controller; when one wants to take out the multi-functional remote controller from the accommodating space, press the multi-functional remote controller, which may pop out of the accommodating space for easy access; when one wants to put the multi-functional remote controller back into the accommodating space after use, put and press the multi-functional remote controller into the accommodating space, in order to fix the multi-functional remote controller in the accommodating space.

In addition, the multi-functional remote controller has a plurality of ring-shaped multi-tasking selection buttons, a selection button, a volume button, and an e-sport ambient light; wherein, the plurality of ring-shaped multi-tasking selection buttons are disposed on both sides of the multi-functional remote controller, the selection button and the volume button are respectively disposed on the downside and the upside of the multi-functional remote controller, and the e-sport ambient light is disposed on top of the multi-functional remote controller.

When the multi-functional remote controller is used as a traditional remote control for watching audio-visual platforms, the multi-functional remote controller is used in a vertical mode. In addition to using the selection button and the volume button to select an audio-visual platform one wants to watch and adjusting the volume, an adjustment may also be done through the plurality of ring-shaped multi-tasking selection buttons. When the multi-functional remote controller is used as a game handle, the multi-functional remote controller is used in a horizontal mode; the plurality of ring-shaped multi-tasking selection buttons may be used as arrow keys and operational keys on a general game handle, so as to solve the problem of conventional remote controls having inconvenient operation when used as a game handle due to poor button design. On the other hand, the e-sport ambient light changes color or brightness according to gaming scenarios when a user is playing a game, so as to enhance the user's gaming experience.

The technical features of the present disclosure are to be illustrated in detail below with specific embodiments and accompanying drawings to make a person with ordinary skill in the art effortlessly understand the purposes, technical features, and advantages of the present disclosure.

### BRIEF DESCRIPTION OF THE DRAWINGS

The exemplary embodiments of the present disclosure are to be more fully understood from the following detailed description and the accompanying drawings of various embodiments of the present disclosure, which, however, should not be regarded as limiting the present disclosure to particular embodiments, but are only used for illustrative and understanding purposes only.

FIG. 1 is a three-dimensional schematic diagram of the vehicle rear seat entertainment integration module according to the present disclosure;

FIG. 2 is a rear view of the vehicle rear seat entertainment integration module according to the present disclosure;

FIG. 3 is a top view of the vehicle rear seat entertainment integration module according to the present disclosure;

FIG. 4 is a schematic diagram of disposing a ring-shaped ambient light outside the bracket fixing slot of the vehicle rear seat entertainment integration module according to the present disclosure;

FIG. 5A to 5C are schematic diagrams of taking the multi-functional remote controller from the vehicle rear seat entertainment integration module according to the present disclosure;

FIG. 6A to 6C are schematic diagrams of pressing structure and the operation thereof of the multi-functional remote controller from the vehicle rear seat entertainment integration module according to the present disclosure;

FIG. 7 is a schematic diagram of the structure of the multi-functional remote controller in the vehicle rear seat entertainment integration module according to the present disclosure;

FIG. 8 is a schematic diagram of the usage mode of the multi-functional remote controller in the vehicle rear seat entertainment integration module according to the present disclosure.

### DESCRIPTION OF THE PREFERRED EMBODIMENTS

To make the features, contents, and advantages as well as the effects achieved by the present disclosure clearly expressed, the present disclosure is to be described in detail in conjunction with the form of the accompanying drawings. In addition, the drawings herein are used only for the purpose of indicating and supporting the specification, which is not necessarily the real proportion and precise configuration after the implementation of the present disclosure. Therefore, the relations of the proportion and configuration of the attached drawings should not be interpreted to limit the actual scope of implementation of the present disclosure.

To make a more complete and clearer disclosure of the technical contents, the purpose of the present disclosure, and the effects achieved by the present disclosure, they are described in detail below. Please refer to the disclosed drawings and drawing numbers together.

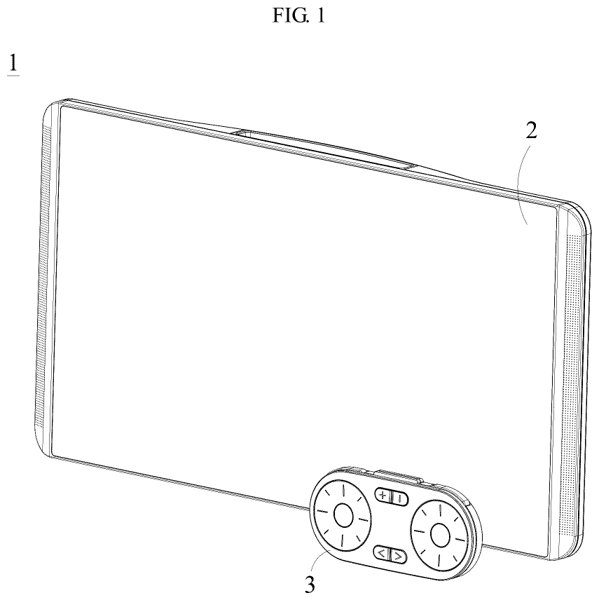

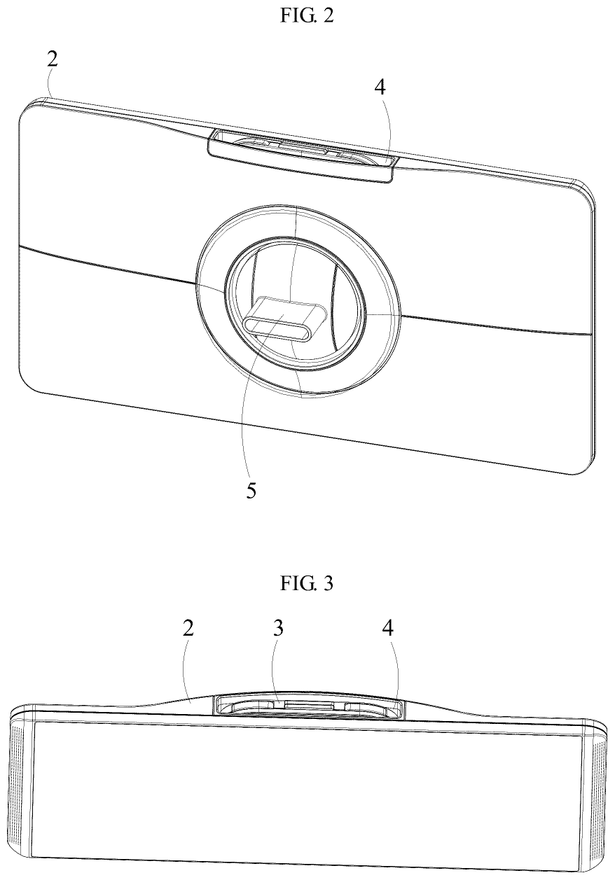

Please refer to FIG. 1 to FIG. 3, which, in sequence, are a three-dimensional schematic diagram, a rear view, and a top view of the vehicle rear seat entertainment integration module of the present disclosure.

The vehicle rear seat entertainment integration module 1 includes a display 2 and a multi-functional remote controller 3; wherein, the top of the display 2 is disposed with an accommodating space 4 for placing the multi-functional remote controller 3; moreover, a bracket fixing slot 5 is provided at the center of the back of the display 2, which is combined with the bracket fixing seat 5 at the headrest of the rear seat of the vehicle, so as to make the display 2 fixed on the rear seat of the vehicle.

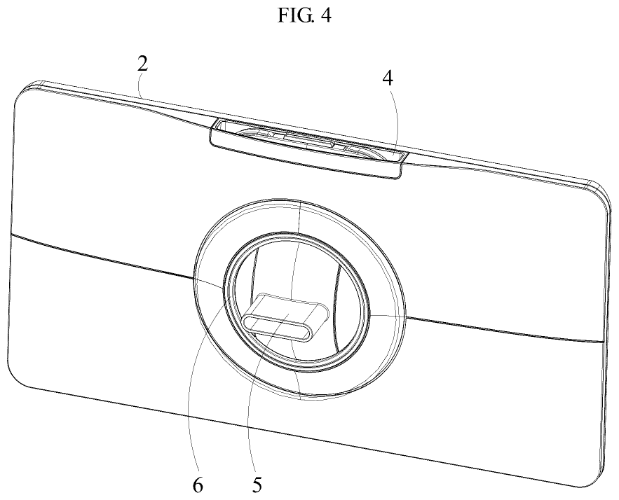

Please refer to FIG. 4, which is a schematic diagram of disposing a ring-shaped ambient light outside the bracket fixing slot of the vehicle rear seat entertainment integration module according to the present disclosure. Preferably, the back of the display 2 may be further disposed with a ring-shaped ambient light 6, which is disposed along the outer side of the bracket fixing slot 5. The ring-shaped ambient light 6 is able to make different adjustments in lighting effects according to usage scenarios of the vehicle rear seat entertainment integration module, so as to enhance the user experience. For example, when music is played, the light may change color or brightness along with the music, or when a game is played, the light may respond to the sound effects with corresponding lighting effects.

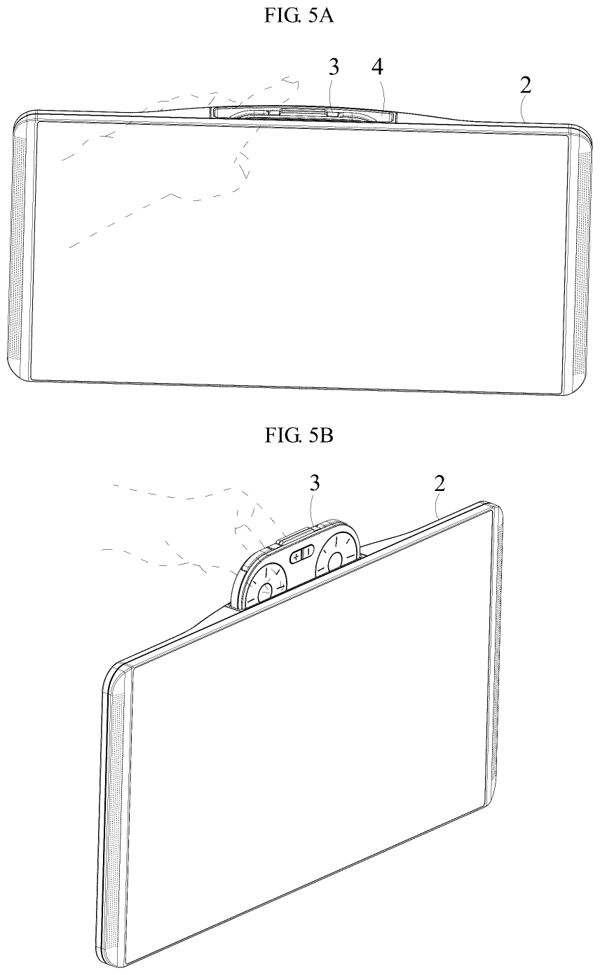

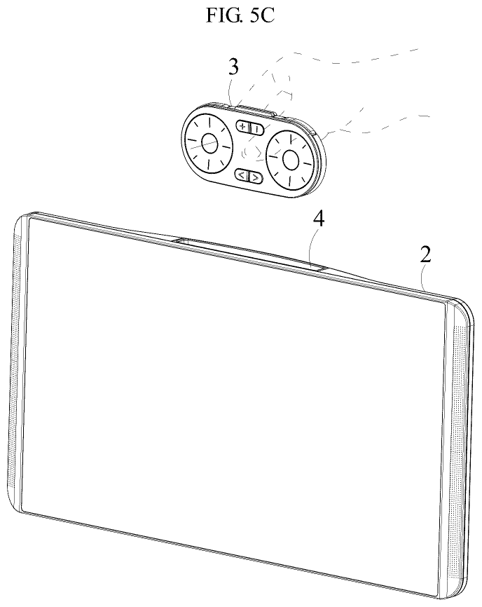

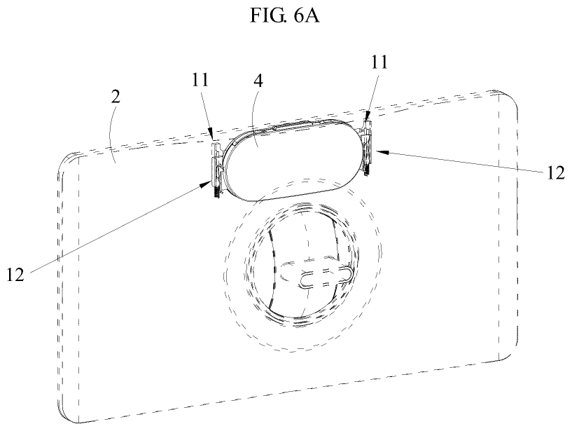

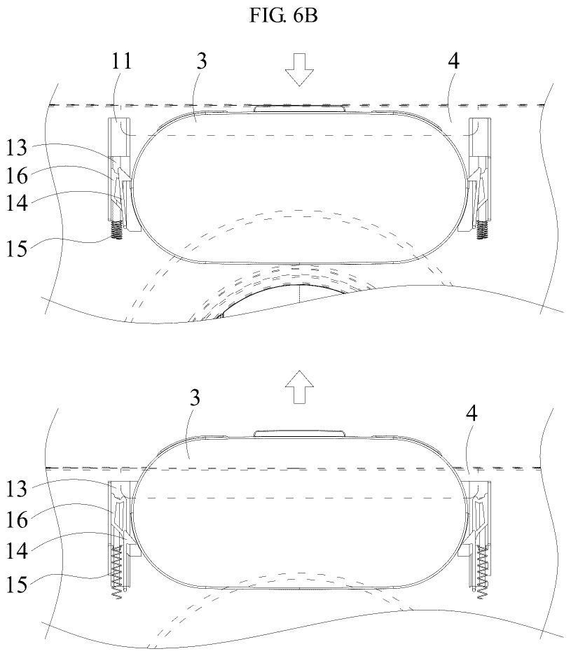

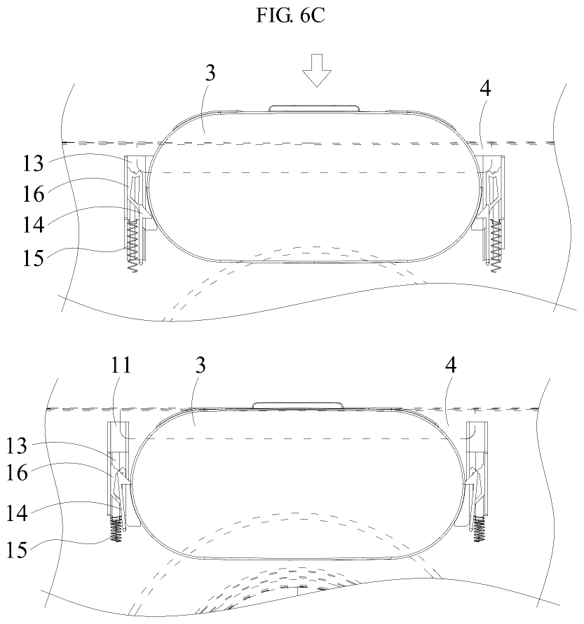

Next, please also refer to FIG. 5A to FIG. 5C together, which are schematic diagrams of taking the multi-functional remote controller from the vehicle rear seat entertainment integration module according to the present disclosure. The accommodating space 4 may be further disposed with a pressing structure 12 (as shown in FIG. 6A to FIG. 6C) to facilitate the removal or fixation of the multi-functional remote controller 3. Specifically, the display 2 may be provided with pressing structure accommodating grooves 11 at inner part of both sides of the accommodating space 4 respectively, so that the pressing structure 12 may be placed therein. The pressing structure 12 may be smaller in size than the pressing structure accommodating groove 11 in order to be fitted in, and thus the pressing structure 12 may move within the pressing structure accommodating groove 11.

The pressing structure 12 may include a sliding component 13, a fixing component 14 and a spring 15. The sliding component 13 may be provided with an engaging component 16 that fits with the fixing component 14 The sliding component 13 may be disposed above the spring 15, and the fixing component 14 may be disposed on the side of the spring 15 parallel to the sliding component 13. When the multi-functional remote controller 3 is to be removed from the accommodating space 4, the multi-functional remote controller 3 may be pressed to compress the spring 15, such that the fixing component 14 may be separated from the engaging component 16. At this time, the sliding component 13 would slide upward by the elastic force of the spring 15, thereby pushing out the multi-functional remote controller 3 form the accommodating space 4, which may pop out of the accommodating space 4 for easy access (referring to FIG. 6B). When the multi-functional remote controller 3 is to be put back into the accommodating space 4 after use, the multi-functional remote controller 3 may be put and pressed into the accommodating space 4, the sliding component 13 would slide downward to compress the spring 15, and the fixing component 14 and the engaging component 16 may be engaged and fixed to each other by the elastic force of the spring 15, thereby fixing the multi-functional remote controller 3 in the accommodating space 4 (referring to FIG. 6C).

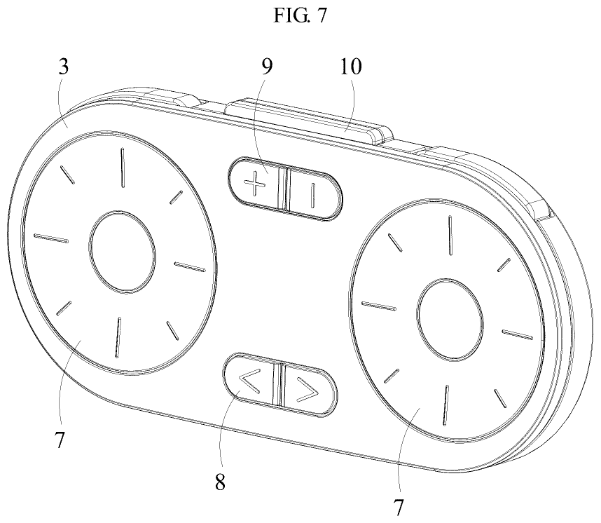

Furthermore, please refer to FIG. 7, which is a schematic diagram of the structure of the multi-functional remote controller in the vehicle rear seat entertainment integration module according to the present disclosure; the multi-functional remote controller 3 has a plurality of ring-shaped multi-tasking selection buttons 7, a selection button 8, a volume button 9, and an e-sport (e.g., gaming) ambient light 10. Wherein, the plurality of ring-shaped multi-tasking selection buttons 7 are disposed on both sides of the multi-functional remote controller 3, the selection button 8 and the volume button 9 are respectively disposed on the downside and the upside of the multi-functional remote controller 3, and the e-sport ambient light 3 is disposed on top of the multi-functional remote controller 10.

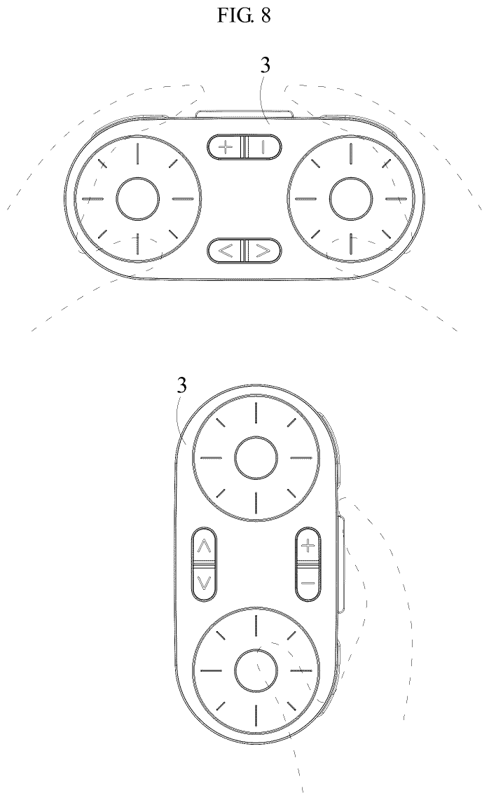

Finally, please refer to FIG. 8 together, which is a schematic diagram of the usage mode of the multi-functional remote controller in the vehicle rear seat entertainment integration module according to the present disclosure. When the multi-functional remote controller 3 is used as a traditional remote control for watching audio-visual platforms, the multi-functional remote controller 3 is used in a vertical mode. In addition to using the selection button 8 and the volume button 9 to select an audio-visual platform one wants to watch as well as adjusting the volume, an adjustment may also be done through the plurality of ring-shaped multi-tasking selection buttons 7. When the multi-functional remote controller 3 is used as a game handle, the multi-functional remote controller 3 is used in a horizontal mode; the plurality of ring-shaped multi-tasking selection buttons 7 may be used as the arrow keys and operational keys of the general game handle, so as to solve the problem of conventional remote controls having inconvenient operation when used as a game handle due to poor button design. On the other hand, the e-sport ambient light 10 changes color or brightness according to gaming scenarios when the user is playing the game, so as to enhance the user's gaming experience.

In summary, the vehicle rear seat entertainment integration module provided by the present disclosure indeed solves the problem of storing the remote control; the button layout of the remote control has been redesigned so as to be used as a game handle by changing the way of holding in addition to being used as a traditional remote control; this solves the problem of inconvenient operation due to poor button design. In addition, the ring-shaped ambient light at the back of the display and the e-sport ambient light on top of the multi-functional remote controller may be used to enhance the user experience with different lighting effects according to usage scenarios.

The embodiments of the present disclosure covered by the patent application are defined by the present claims, not by the summary of the invention. The summary of the invention is a high-level generalization of the various aspects of the present disclosure and introduces some concepts further described in the following detailed description. The summary of the invention is not intended to identify the essential or necessary features of the claimed subject matter, nor is it intended to be used solely to define the claimed subject matter. The subject matter should be understood by reference to the entire specification, any or all of the drawings, and the appropriate portion of every claim of the present disclosure.

1. A vehicle rear seat entertainment integration module, comprising:
a display; and
a multi-functional remote controller, wherein
a top of the display being disposed with an accommodating space for placing the multi-functional remote controller;
a bracket fixing slot is provided at a center of a back of the display; and
the accommodating space is disposed with a pressing structure.

2. The vehicle rear seat entertainment integration module according to claim 1, wherein the multi-functional remote controller is removed from or fixed in the accommodating space by the pressing structure.

3. The vehicle rear seat entertainment integration module according to claim 1, wherein the display is further disposed with a ring-shaped ambient light, and the ring-shaped ambient light is disposed along an outer side of the bracket fixing slot, which makes different changes in lighting effect according to usage scenarios of the vehicle rear seat entertainment integration module.

4. The vehicle rear seat entertainment integration module according to claim 1, wherein the multi-functional remote controller comprises:
a plurality of ring-shaped multi-tasking selection buttons, being disposed on both sides of the multi-functional remote controller;
a selection button, being disposed on a downside of the multi-functional remote controller;
a volume button, being disposed on an upside of the multi-functional remote controller; and
an e-sport ambient light, being disposed on top of the multi-functional remote controller.

5. The vehicle rear seat entertainment integration module according to claim 4, wherein the multi-functional remote controller is configured to be used in a vertical mode and/or a horizontal mode.

6. The vehicle rear seat entertainment integration module according to claim 5, wherein when the multi-functional remote controller is used as a traditional remote controller, the multi-functional remote controller is used in the vertical mode.

7. The vehicle rear seat entertainment integration module according to claim 5, wherein when the multi-functional remote controller is used as a game handle, the multi-functional remote controller is used in the horizontal mode.

8. The vehicle rear seat entertainment integration module according to claim 7, wherein the e-sport ambient light changes color or brightness according to gaming scenarios.
